(19) United States
(12) Patent Application Publication
(10) Pub. No.: US 2012/0205326 A1
(43) Pub. Date: Aug. 16, 2012

(54) POWERED SECURITY DISPLAY DEVICE

(75) Inventors: Gary M. Richter, Waukesha, WI (US); Ryan Brobst, Grafton, WI (US)

(73) Assignee: DCI Marketing, Inc. (a Wisconsin corporation), Milwaukee, WI (US)

(21) Appl. No.: 13/369,153

(22) Filed: Feb. 8, 2012

Related U.S. Application Data
(60) Provisional application No. 61/440,775, filed on Feb. 8, 2011.

(51) Int. Cl. A47F 1/04; H02J 1/06; E05B 73/00

(52) U.S. Cl. 211/4; 307/38

(57) ABSTRACT

A powered security display device displays items in the retail environment. The display device is configured to removably attach to an item while simultaneously providing power to the device and including an alarm such that if the item is removed without authorization, the alarm is activated.

### CROSS-REFERENCE TO RELATED APPLICATION

This application is based on and claims priority to U.S. Provisional Patent Application No. 61/440,775 filed on Feb. 8, 2011, which is incorporated herein by reference in its entirety for all purposes.

### FIELD OF THE INVENTION

The present invention relates generally to the field of advertising displays. More particularly, the present invention relates to a display device for displaying and powering an item to allow it to be manipulated easily by the user while also prohibiting the unauthorized removal of the item from the premises.

### BACKGROUND

In the field of advertising displays, there is a need to display small items, typically electronics such as cell-phones, camcorders, cameras, and remote controls in a way that allows consumers to touch and hold the devices prior to purchase. Traditionally, such items were displayed in locked cases or behind counters where consumers could only get access to the items after consulting a sales associate. As the number of small electronic devices available for purchase increased dramatically, it became necessary for retailers to change the way small electronics are displayed. Retailers want to allow potential customers to be able to handle the devices in the store, but lack the staffing and/or security to allow them to do so without fear of rampant theft. Small electronic devices, even so called “dummy” phones, are valuable and are attractive targets for thieves. In order to facilitate customer interaction with the devices while simultaneously preventing theft, retailers employ a wide variety of security measures.

One common solution to the above problem has been to anchor the item to a shelf, table, or display. Retailers have implemented a wide range of anchors, but most fall into one of two categories: recoiling tether with mechanical attachment, or recoiling tether with adhesive attachment. Both solutions have also been adapted to provide power to the device and/or alarm capabilities in the event that the device is removed from the tether. Both solutions have significant limitations.

Typical mechanical attachment systems are comprised of a spool and cable that are attached to a cage or mechanical claw that wraps around the secured device and locks in place. Such mechanical attachment solutions tend to be quite bulky due to the fact that they are adjustable in order to accommodate devices of varying size and shape. The adjustable nature of the mechanical attachment also necessitates that mechanical attachments are more complex than an adhesive attachment. Mechanical attachment systems are also typically made of metal components. All of the above mentioned characteristics of mechanical attachment systems contribute to their increased cost over simpler anchor systems. The added bulk of the mechanical attachment also diminishes the consumer experience because the potential buyer is unable to get a true sense of the size and feel of the secured device.

Adhesive attachment solutions tend to be much less bulky than their mechanical counterparts but suffer from a critical limitation: once the adhesive is attached to the device, it is very difficult, if not impossible to remove it without damaging either the anchor or the secured device. The ability to remove the devices from the tether attachment assembly is important if and when the store wishes to re-planogram. As used herein “planogram” refers to a diagram of fixtures and products that illustrates how and where retail products should be displayed to increase customer purchases. In the rapidly changing world of cell phones and small electronics, the retailer's ability to quickly and easily move products around the retail environment without damaging the products or the displays is extremely important.

As such, there is a need for an anchor for displaying items that includes a tether, provides power to the device, and can incorporate an alarm system, but is not bulky like the mechanical attachment and allows stores to be easily and quickly reconfigured without damaging the small item or the anchor.

### SUMMARY

The present invention relates to a display system that provides power to displayed items and includes an integrated alarm system. The display system includes a controller housing, and at least one item display, which includes an item display housing, a riser, and an attachment pad. The controller housing encloses a first printed circuit board configured to provide power and alarm controls to a plurality of display devices. The controller housing may be mounted to a display surface, which includes a customer facing and a non-customer facing side, or mounted elsewhere.

At least one item display is mounted to the display surface. The item display housing is mounted to the non-customer facing side of the display surface and contains a second printed circuit board configured to communicatively connect to the first printed circuit board and a portion containing a first end of a recoil cable adapted to connect to a third printed circuit board. The riser is adapted to attach to the customer facing side of the display surface and to offset the displayed item a specific distance from the customer facing side of the display surface.

The pad is attaches to a second end of the recoil cable and extends away from the riser. The pad encloses the third printed circuit board, a plate, a switch, a piece of double-sided adhesive tape, and a back cover. The displayed item is permanently attached to the attachment plate by adhering the adhesive tape to the item. The system further includes a key that allows a user to partially disassemble the pad such that the plate may be detached from the rest of the pad, thereby allowing the displayed item to be detatched from the display device and re-attached to another display device elsewhere in the store.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a partially exploded perspective view of one embodiment of a display device in accordance with the invention;

FIG. 2 is a detailed exploded perspective view of a portion of the display device of FIG. 1;

FIG. 3 is top view of a portion of the display device of FIG. 1;

FIG. 4 is a front view of a portion of the display device of FIG. 1;

FIG. 5 is a side view of a portion of the display device of FIG. 1;

FIG. 6 is a perspective view of one embodiment of a display device housing in accordance with the invention;

FIG. 7 is an exploded view of the display device housing of FIG. 6;

FIG. 8 is a perspective view of one embodiment of an attachment pad and recoil cable in accordance with the invention;

FIG. 9 is an exploded perspective view of the attachment pad and recoil cable of FIG. 8;

FIG. 10 is another perspective view of the attachment pad and recoil cable of FIG. 8;

FIG. 11 is a perspective view of one embodiment of a key in accordance with the invention;

FIG. 12 is a perspective view of one embodiment of a riser in accordance with the invention; and

FIG. 13 is an exploded perspective view of the riser of FIG. 11.

### DETAILED DESCRIPTION

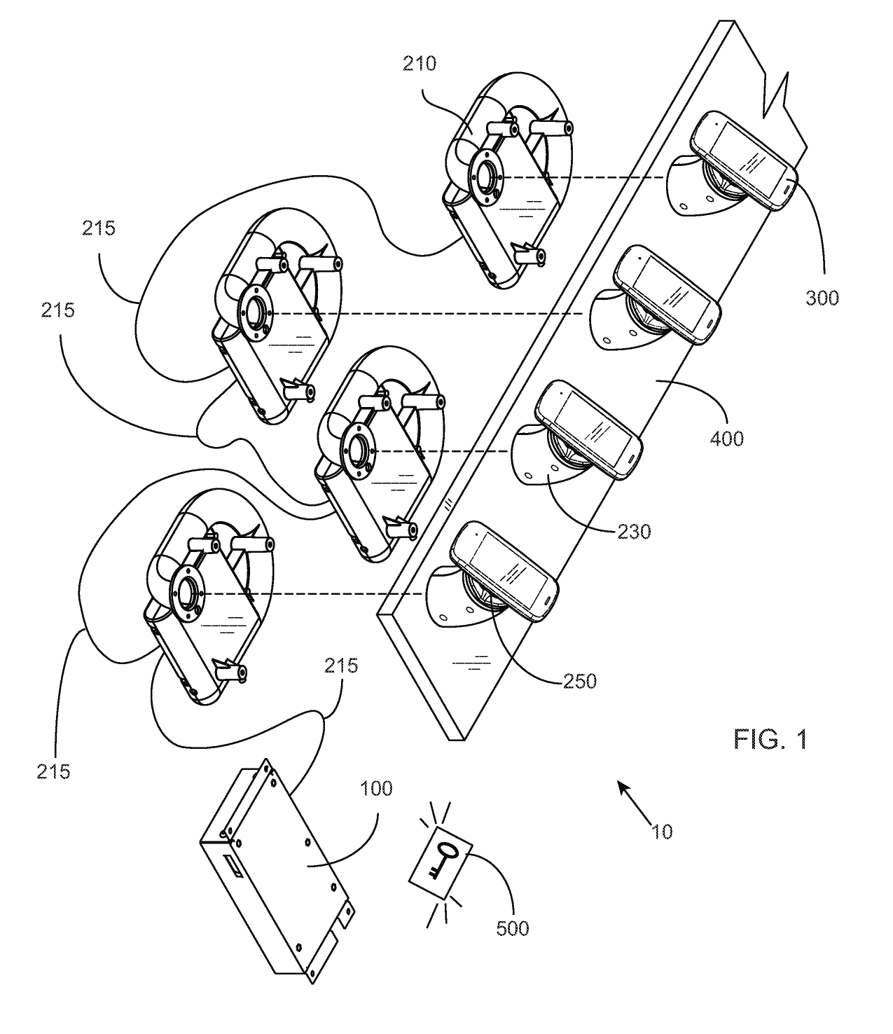

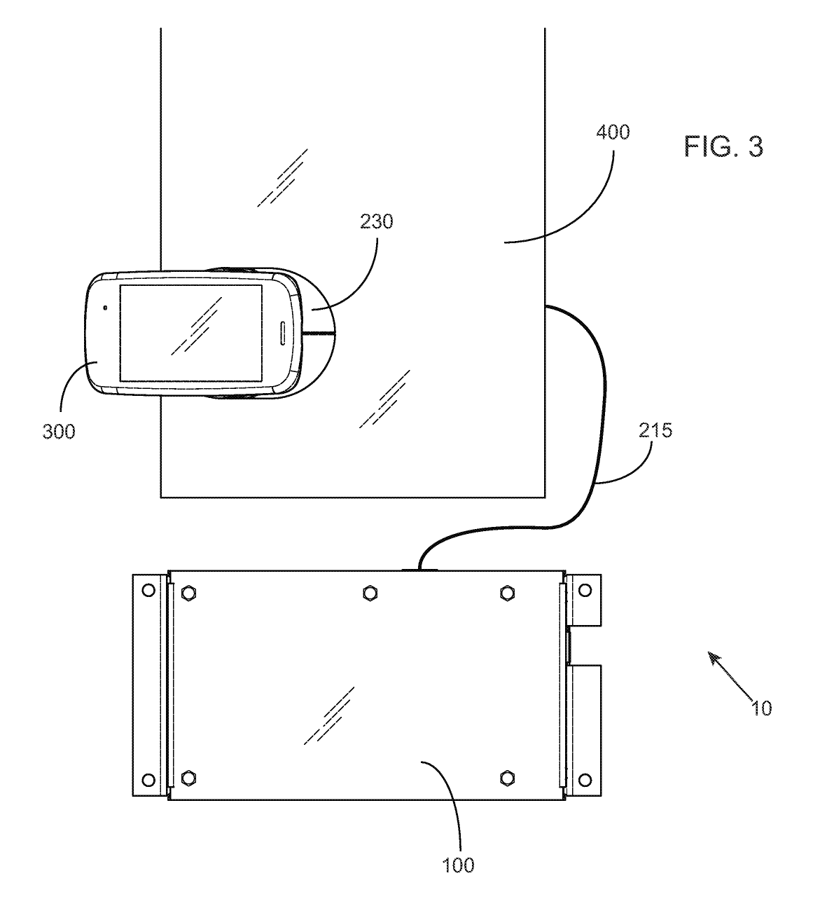

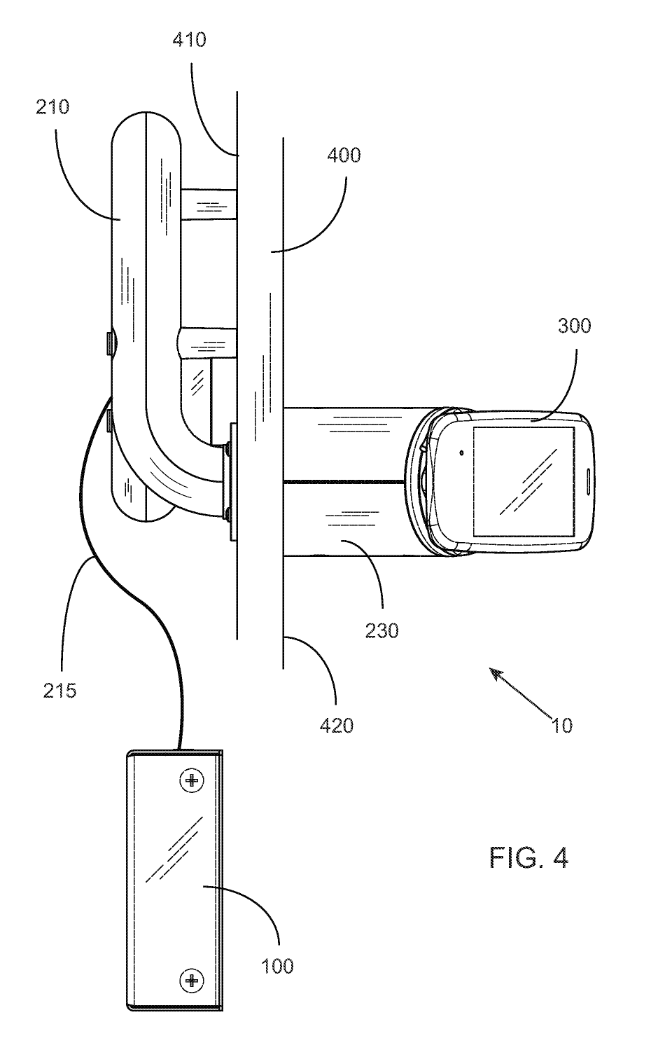

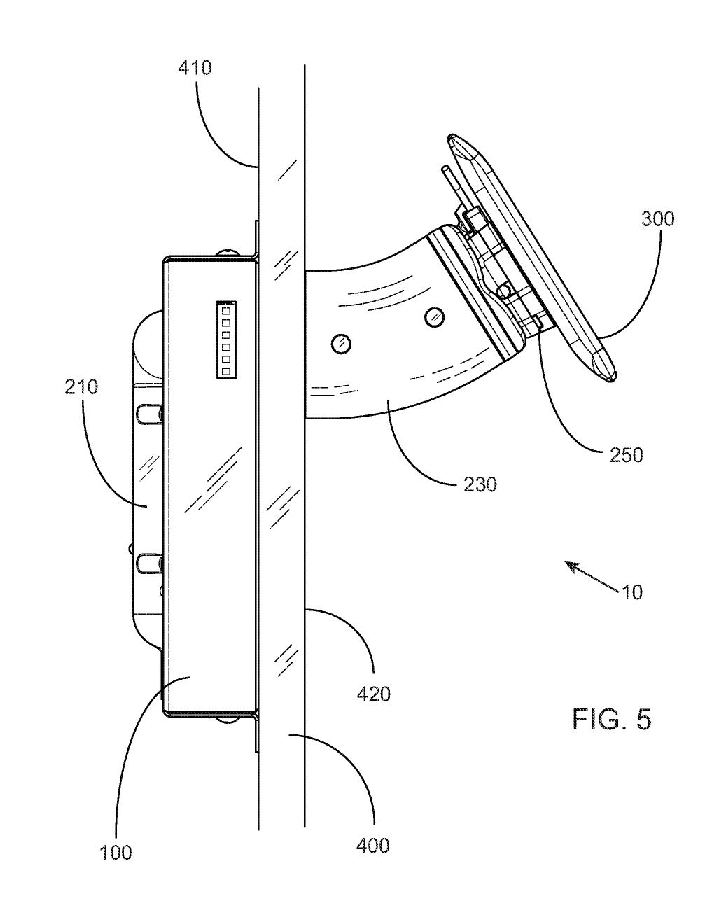

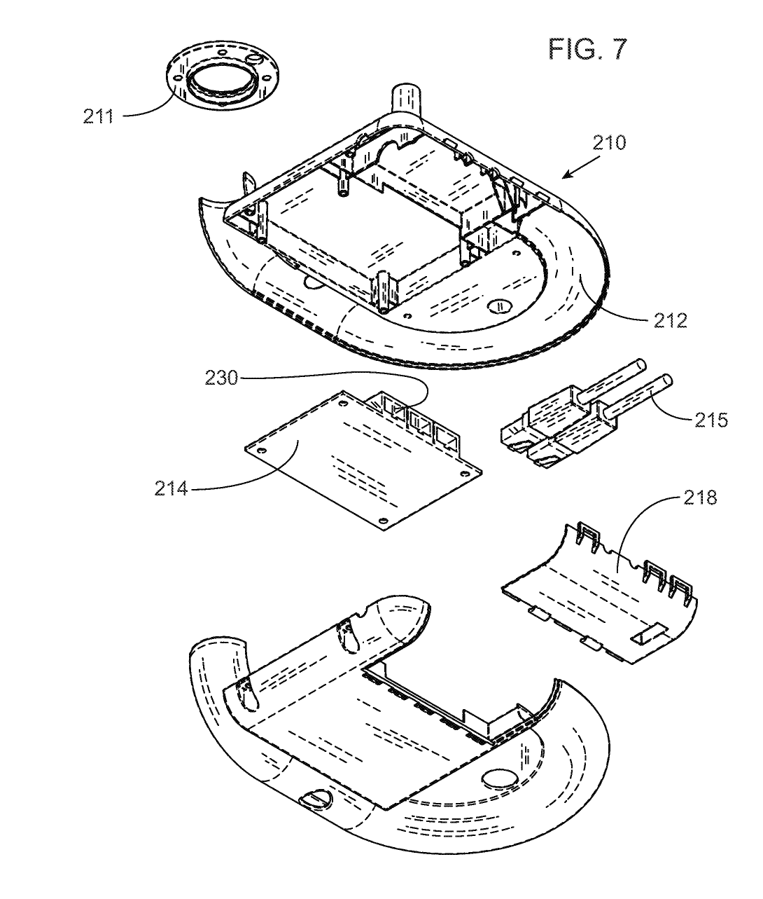

FIGS. 1-5 show one embodiment of a display device 10 in accordance with the invention. The display device 10 includes a controller 100 and at least one item display 200. Each item display 200 includes a item display housing 210, an attachment pad 250, and a riser 230. The display device 10 is adapted to securely display at least one item 300 on a display surface 400 in a retail environment. In the embodiment shown, the item display housing 210 is attached to a non-customer facing side 410 of the display surface 400, with the riser 230 attached to a customer facing side 420. The display surface 400 includes a hole 430 wherever an item display 200 is mounted. The attachment pad 250 is attached to a first end of a recoil cable 222 that passes through the riser 230 and hole 430, and is attached at a second end to a second printed circuit board 214 (see FIG. 7) enclosed in the item display housing 210.

The display device 10 is controlled by the controller 100. The controller 100 contains a first printed circuit board (not shown) and provides power to the display device 10. The controller 100 also controls an alarm system that sounds an audible alarm if the item 300 is removed from the display device, and performs other functions relating to the display device.

The controller 100 is communicatively attached to a plurality of item displays 200. In the embodiment shown, the plurality of item displays 200 are connected together in series by a plurality of electrical cables 215. In such a “daisy-chain” configuration, each successive item display 200 is connected to the previous item display. Thus, it is not necessary to connect each item display 200 to the controller individually. In alternative embodiments, the item display 200 may be powered by batteries and configured to communicate wirelessly with the controller 100, thereby eliminating the need for the electrical cables 215.

Once connected, information may be shared between the controller 100 and the item display 200. For example, the display device 10 may capture metrics including but not limited to: how often and for how long an item 300 is picked up by a customer and the model/serial number information of the item 300. Capturing such data is particularly advantageous when creating a new planogram for the store. Additionally, the controller 100 may communicate to the item display 200 or to the item 300. For example, the controller 100 may send signals to the item 300 to display an image on the item's screen when the item is picked up, or to keep the screen illuminated while the store is open for business.

The display system's 10 primary purpose, however, is to be an alarm system to prevent theft of the item 300. An operator either arms or disarms the alarm system using a controller key 500. In the embodiment shown, the controller key 500 is a radio-frequency identification (RFID) card, but other keys may be used without departing from the invention. Alternatively, the retailer may disable the need for a controller key 500 to arm or disarm the alarm system if the controller 100 is placed in a secure location. When the alarm system is armed, any removal of the item 300 from the item display 200 or any severing of the electrical connections between the item displays and the controller 100 will result in an audible alarm being activated. In alternative embodiments, the controller key 500 may include identifying information such as the ID of the employee to which the controller key was issued. Such information would allow the retailer to monitor the activities of its employees to further deter theft.

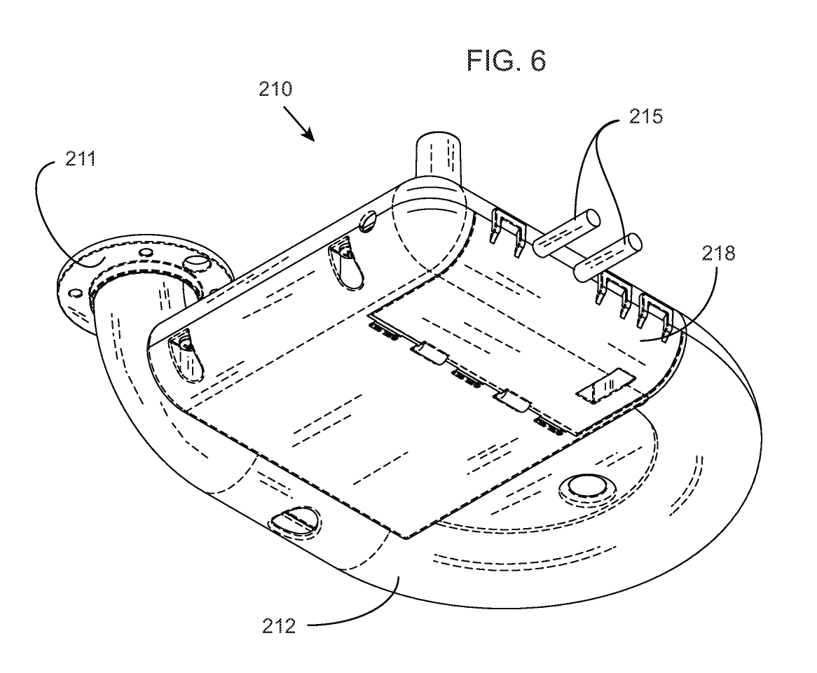

Turning now to FIGS. 6-7, an item display housing 210 in accordance with the invention is shown. The item display housing 210 is adapted to attach to the non-customer facing side 410 of the display surface 400. The item display housing 210 includes a mounting flange 211 to facilitate the attachment of the item display housing to the customer facing side 410 of the display surface 400. In the embodiment shown, a plurality of threaded fasteners (not shown) are used to mount the item display housing 210. Additional mounting means may also be utilized to securely attach the item display housing 210 to the display surface 400.

The item display housing 210 encloses a recoil cable 222 in a channel 212 and a second printed circuit board 214. The second printed circuit board 214 includes a plurality of ports 216 for connecting the item display 200 to other item displays and the controller 100 using electrical cables 215. An additional port (not shown) is included where one end of the recoil cable 222 is attached. In the embodiment shown, the item display housing 210 includes an access door 218 to allow access to the printed circuit board 214.

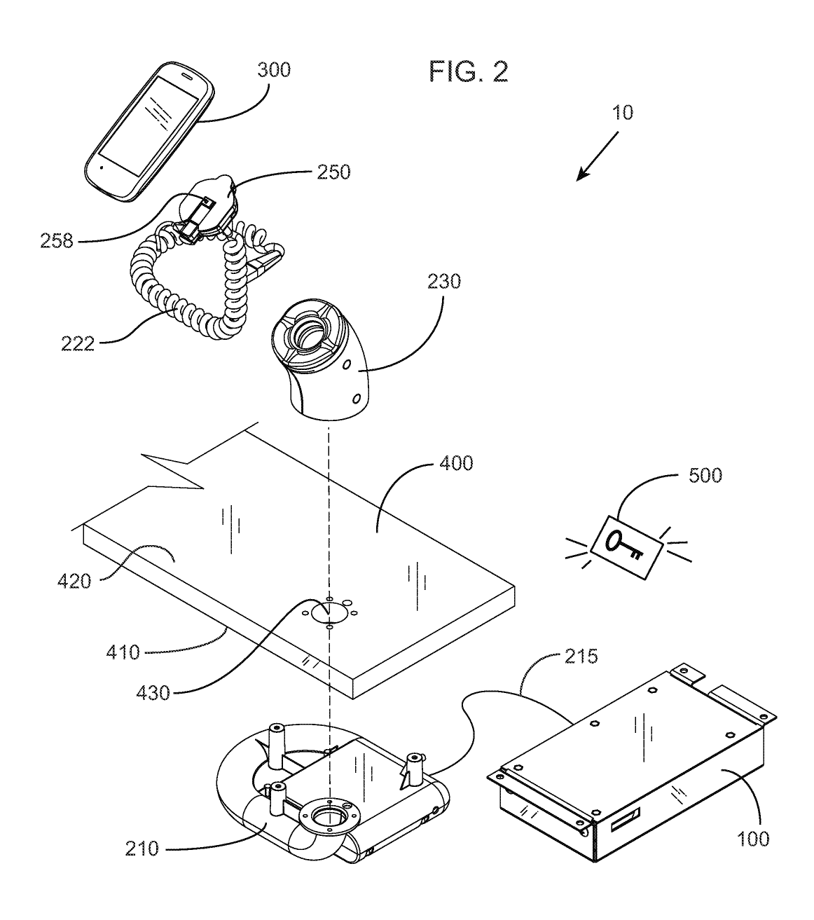

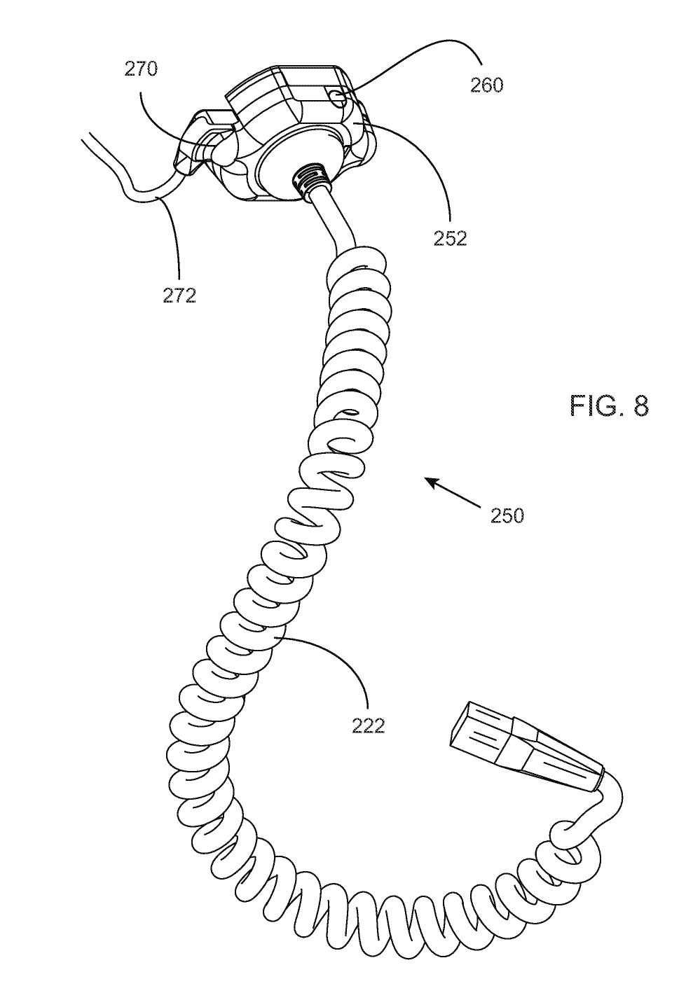

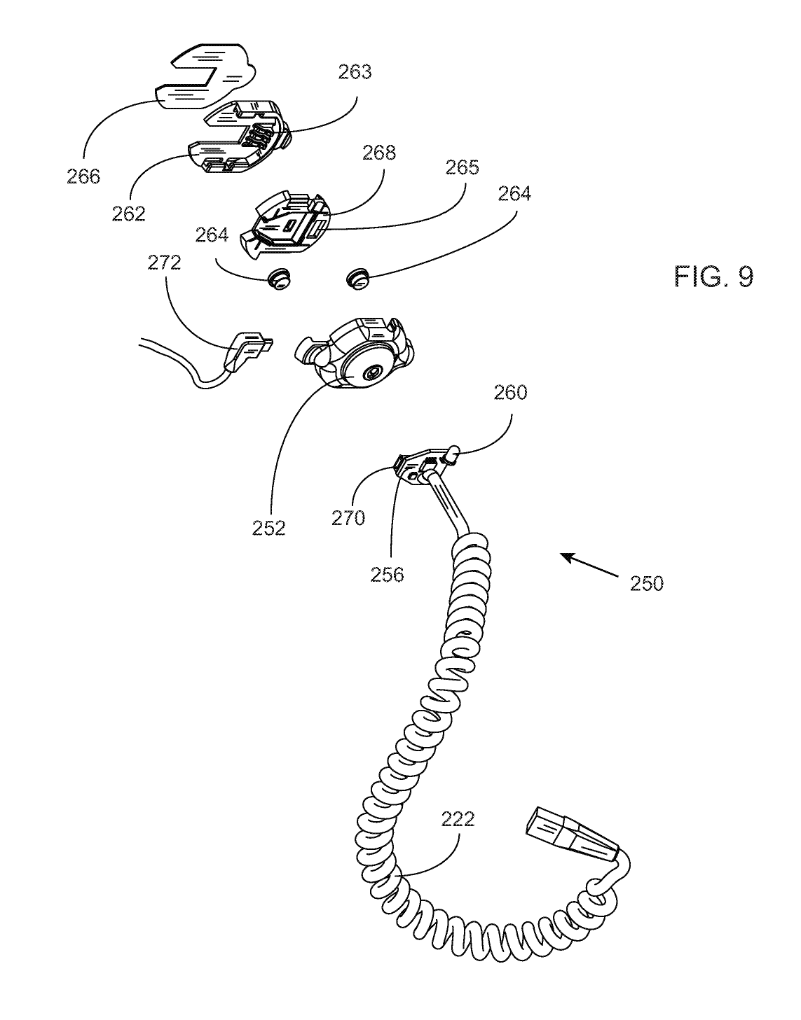

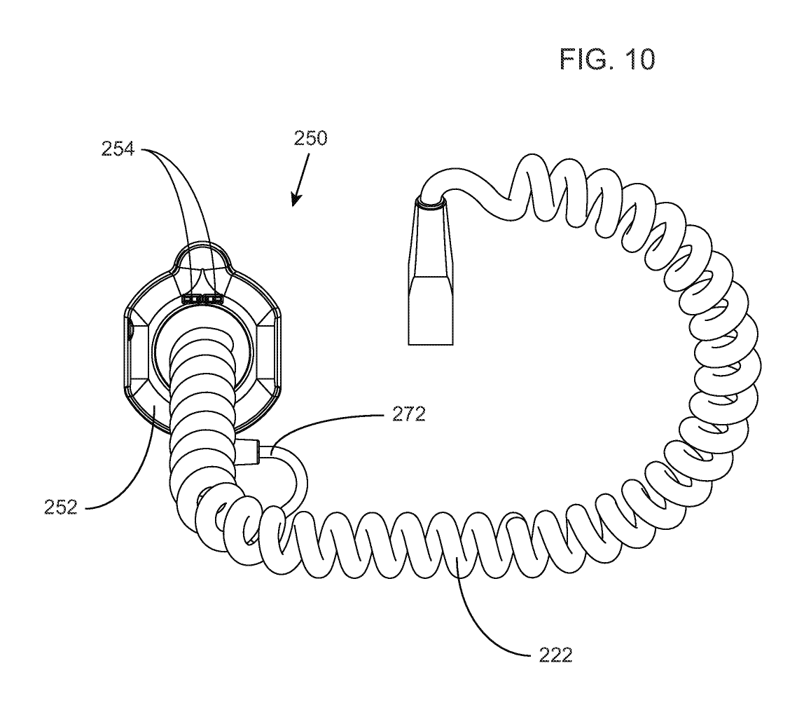

Turning now to FIGS. 8-10, an attachment pad 250 in accordance with the invention is shown. In the embodiment shown, the attachment pad 250 includes a number of components including a back cover 252 that includes at least one keyhole 254, a third printed circuit board 256, a switch 258 (see FIG. 2), a visual indicator 260, a plate 262, pad alignment magnets 264 and adhesive 266. The third printed circuit board 256 is retained within the attachment pad 250 by a support piece 268. The attachment pad 250 may be made of plastic, metal or any other suitable material.

The attachment pad 250 may also include means for electrically connecting the item 300 attached to the pad to an electrical source. In the embodiment shown, the connection includes a socket 270 and cable 272. As shown, the socket 270 is a mini-USB connector, but others may be used without departing from the invention.

The pad alignment magnets 264 interact with riser alignment magnets (not shown) to align the attachment pad 250 in a desired orientation when the attachment pad is seated on the riser 230. Additionally, the magnets help secure the item 300 in the riser 230.

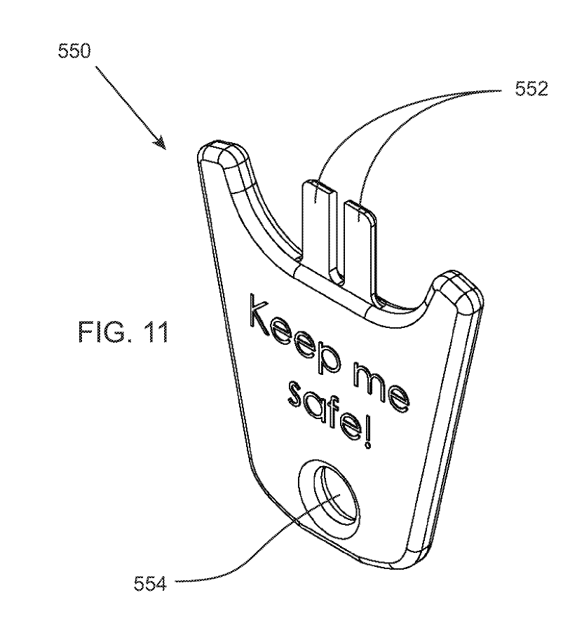

The plate 262 includes at least one resilient finger 263 that locks the plate to the attachment pad 250. To install the plate 262 on the attachment pad 250, the plate is slid vertically onto the back cover 252 such that the resilient finger 263 passes over a ridge 265 on the support piece 268. When the resilient finger 263 passes over the ridge 265, it deforms slightly so that when the plate 262 is in its final position, the resilient finger springs into position proximate the ridge. When the plate 262 is properly installed, it may not be removed from the attachment pad 250 unless an attachment pad key 550 (see FIG. 11) is used to depress the resilient finger 263, thereby allowing it to pass back over the ridge 265. Once the plate 262 is disengaged from the attachment pad 250, it, along with anything attached to it, may be easily moved and attached to another attachment pad 250 elsewhere in the store. Likewise, another plate 262 from a different location in the store may be similarly attached to the attachment pad 250 just vacated. Thus, retailers may quickly and easily re-arrange their displays by simply moving plates 262 between attachment pads 250.

The plate 262 is attached to the item 300 using adhesive 266 on the front surface 270 of the plate. In the embodiment shown, the adhesive 266 is double-sided tape, although other adhesives may also be used. The attachment pad 250 also includes a switch 258 that is open when there is not an item attached to the attachment pad, and closed when an item 300 is adhered to the attachment pad. If the item 300 is removed from the attachment pad 250 the switch 258 automatically switches to the open position. If the item 300 is removed while the alarm is armed, the activation of the switch 258 causes an audible alarm to sound. In the embodiment shown, the visual indicator 260 illuminates when the system is armed. In alternative embodiments, the visual indicator may be configured to display additional colors or to flash to indicate the status of the attachment pad 250.

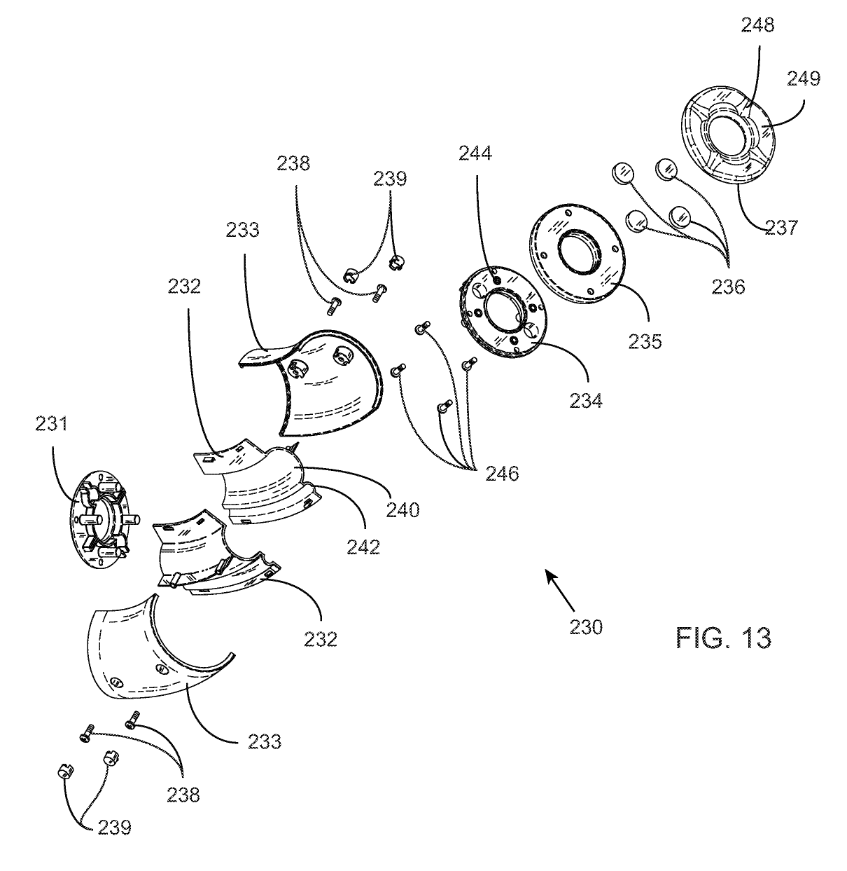

FIG. 11 shows an attachment pad key 550 that may be used to partially disassemble the attachment pad 250. As shown, the attachment pad key 550 includes at least one blade 552 that is adapted to fit into the keyhole 254 on the back cover 252 (see FIG. 13). The attachment pad key 550 also includes a key chain hole 554 for attachment to a key chain, key fob, or other place. In the embodiment shown, the attachment pad key 550 is made of plastic but other suitable materials may be used without departing from the invention.

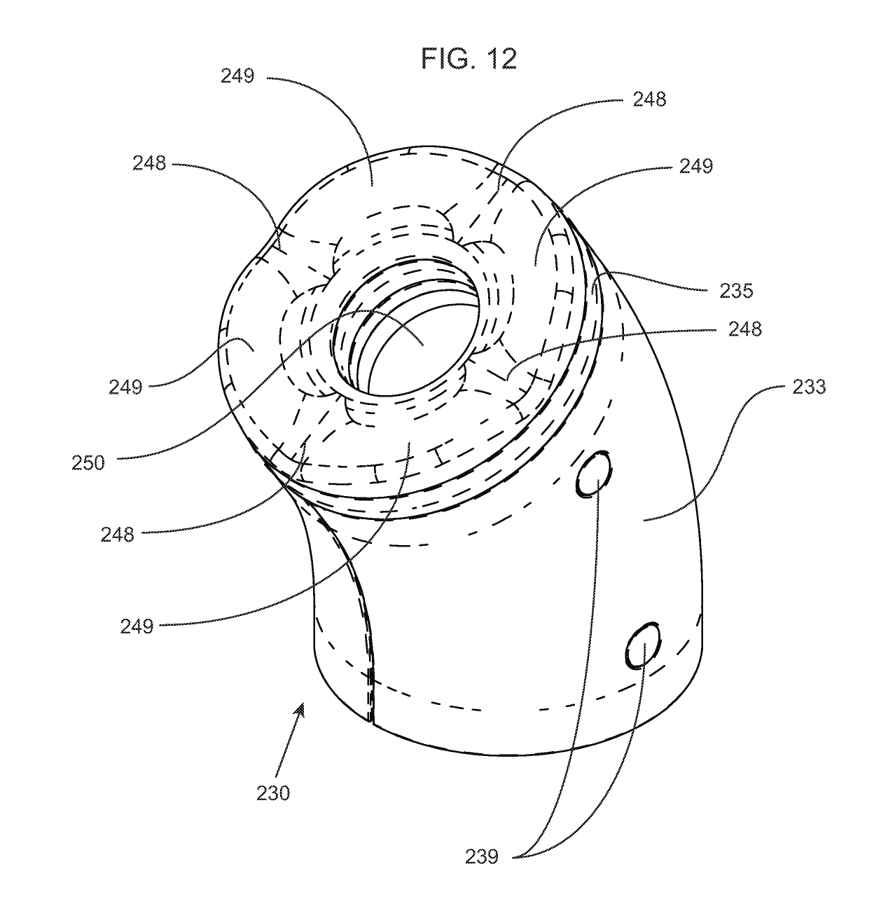

Referring now to FIGS. 12-13, a riser 230 in accordance with the invention is shown. The riser 230 is adapted to offset the attachment pad 250 from the customer facing side 420 of the display surface 400. In the embodiment shown, the riser 230 includes a base plate 231, an inner channel 232, an outer housing 233, an upper retention ring 234, an indicator ring 235, a plurality of riser magnets 236, and a contour ring 237.

As shown, the inner channel 232 and outer housing 233 are each made of two halves that are connected together with a plurality of fasteners 238. Fastener covers 239 are then inserted to cover the heads of the fasteners 238. Alternatively, the inner channel 232 and outer housing 233 may be formed as individual pieces or as a combined part. The inner channel 232 includes a primary channel 240 through which the recoil cable 222 may pass. In the embodiment shown, the inner channel 232 further includes an auxiliary channel 242 through which an auxiliary cable (not shown) may pass. The auxiliary cable is used to power and control the indicator ring 235. The indicator ring 235 may be adapted to change color depending on the status of the item 300 or the alarm system. The indicator ring 235 may also be used as an attention getting device. For example, the indicator ring 235 may be illuminated in a variety of colors or the controller 100 may be configured to send a coordinated signal to the indicator rings 235 on a plurality of risers 230 thereby causing the indicator rings 235 to selectively illuminate or change color in a pattern.

The upper retention ring 234 is configured to provide rigidity to the riser 230 and a surface to support the indicator ring 235, the riser magnets 236, and the contour ring 237. As shown, the upper retention ring 234 includes a plurality of holes 244 of varying sizes adapted to attach the upper retention ring 234 to the inner channel 232 and outer housing 233, and to the indicator ring 235 and contour ring 237 by a plurality of fasteners 246. The fasteners 246 are screws, but other fastening means may be used without departing from the invention.

A plurality of riser magnets 236 may be embedded between the indicator ring 235 and the contour ring 237. The riser magnets 236 are configured to interact with the pad alignment magnets 264 (see FIG. 12) to orient the attachment pad 250 in a desired position. Additionally, the contour ring 237 includes a plurality of valleys 248 and peaks 474, which, in conjunction with the aforementioned magnets 236, 234, help orient the attachment pad 250 in position on the riser 230.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A display system comprising:
a controller providing power and alarm controls to a plurality of display devices;
a display surface having a customer facing side and a non-customer facing side;
at least one item display for displaying an item on the display surface, each item display including an item display housing, a riser, and an attachment pad;
the item display housing removably attached to the non-customer facing side of the display surface, the item display housing communicatively connected to the first printed circuit board;
the item display housing further including a portion containing a first end of a recoil cable;
the riser removably attached to the customer facing side of the display surface and offsetting the item from the customer facing side of the display surface;
the attachment pad attached to a second end of the recoil cable and extending away from the riser, the attachment pad including a back cover including at least one keyhole and removably attached to a plate;
the plate including a locking mechanism that prevents the plate from being removed from the attachment pad when the plate is attached to the attachment pad; and
a key dimensioned for insertion into the at least one keyhole so as to release the locking mechanism, thereby allowing the plate to be removed from the attachment pad.

2. The display system of claim 1 wherein the second printed circuit board is further adapted to communicatively connect to additional second printed circuit boards.

3. The display system of claim 1 wherein the attachment pad further includes a status indicator.

4. The display system of claim 1 wherein the attachment pad further includes a presence switch that is actuated when the item is attached to the pad.

5. The display system of claim 1 wherein the attachment pad includes a jack to provide power to the item.

6. The display system of claim 1 wherein the riser and attachment pad include a plurality of magnets that align the item when it is displayed on the riser.

7. The display system of claim 1 wherein the riser includes a status indicator.

8. The display system of claim 1 wherein the riser is contoured to align the item when it is displayed on the riser.

9. The display system of claim 1 wherein the first printed circuit board includes an alarm circuit that sounds an alarm if an item is removed from a display device while the alarm is armed.

10. The display system of claim 9 wherein the alarm is armed and disarmed by a key.

11. The display system of claim 10 wherein the key is a Radio Frequency Identification Card.

12. The display system of claim 11 wherein the key includes identifying information.

13. The display system of claim 1 wherein the item display communicates wirelessly with the controller.

14. The display system of claim 1 wherein the attachment pad further includes a switch.

15. The display system of claim 1 wherein the plate is semi-permanently attached to the item.

16. The display system of claim 1 wherein the plate is semi-permanently attached to the item by adhesive.

17. The display system of claim 1 wherein the locking mechanism includes at least one resilient finger.

18. A display system comprising:
a controller enclosing a first printed circuit board, the controller configured to provide power and alarm controls to a plurality of display devices;
a display surface having a customer facing side and a non-customer facing side;
at least one item display for displaying an item on the display surface, each item display including an item display housing, a riser, and an attachment pad;
the item display housing removably attached to the non-customer facing side of the display surface, the item display housing enclosing a second printed circuit board configured to communicatively connect to the first printed circuit board;
the item display housing further including a portion containing a first end of a recoil cable removably connected to the second printed circuit board;
the riser removably attached to the customer facing side of the display surface and offsetting the item a specific distance from the customer facing side of the display surface;
the attachment pad attached to a second end of the recoil cable and extending away from the riser, the attachment pad enclosing a third printed circuit board, a plate, a switch, a piece of adhesive tape, and a back cover including at least one keyhole;
the plate removably attached to the attachment pad and including at least one resilient finger that engages a surface on the attachment pad when the plate is attached to the attachment pad; and
a key dimensioned for insertion into the at least one keyhole so as to elastically deform the at least one resilient finger thereby allowing the plate to be removed from the attachment pad.
